(19) United States
(12) Patent Application Publication
(10) Pub. No.: US 2025/0213423 A1
(43) Pub. Date: Jul. 3, 2025

(54) PERSONAL MASSAGE DEVICE

(71) Applicant: MysteryVibe Limited, Surrey (GB)

(72) Inventors: Robert Paul WEEKLY, Haslemere (GB); Soumyadip RAKSHIT, London (GB); Shanshan XU, London (GB); David Ian HEYWOOD, Surrey (GB)

(73) Assignee: MysteryVibe Limited, Surrey (GB)

(21) Appl. No.: 18/848,566

(22) PCT Filed: Mar. 22, 2023
(86) PCT No.: PCT/GB2023/050730

§ 371 Date: Sep. 19, 2024

(30) Foreign Application Priority Data
Mar. 22, 2022 (GB) 2204009.1

(51) Int. Cl. A61H 19/00; A61H 23/02

(52) U.S. Cl. CPC A61H 19/34; A61H 19/44; A61H 23/02; A61H 2201/0153; A61H 2201/1666; A61H 2201/169

(57) ABSTRACT

A personal massage device, for interaction with a user's body, comprising: a base comprising a base section and a clitoral stimulation motor, the base section and the clitoral stimulation motor each having a main longitudinal axis, the main longitudinal axis of the clitoral stimulation motor subtending an angle to the main longitudinal axis of the base section; and a shaft comprising a first shaft section and a second shaft section; wherein the base section and the first shaft section form a first flexible section, bendable in a first rotational direction, and the first shaft section and the second shaft section form a second flexible section, bendable in a second rotational direction, such that the device can be bent from a first configuration to a second configuration; wherein a component of the second rotational direction is opposite to the first rotational direction; and the flexible sections resist bending such that the device resists bending from the first configuration to the second configuration and maintains its shape in use.

### FIELD OF THE INVENTION

The present invention relates to personal massage devices.

### BACKGROUND

There are many different types of personal massage device. One type, commonly known as the “vibrator”, has a shaft and a vibration motor which vibrates the shaft. In use, the shaft is inserted into an orifice of the user, such as the vagina or the anus, and vibration of the motor enhances any sexual stimulation provided by the shaft.

It is reported that a user will experience particularly intense sexual stimulation when the shaft comes into contact with that user's Grafenberg spot, or “G-spot”. In general, the position of the “G-spot” is unique to an individual person, and is often difficult to locate.

One problem with known personal massage devices, in particular vibrators, is that they cannot be adapted to suit a particular user. It will be appreciated that individual users' bodies may be very different from one another. For example, the location of one person's “G-spot” may be vastly different to the location of another person's “G-spot”. Thus, one type of vibrator may suit one particular user very well but that type of vibrator may fail to stimulate a different user.

Some vibrators also include a branch off the shaft which can be used to stimulate the user's clitoris whilst the shaft is inside the user's vagina. However, the location of one person's clitoris may be different to the location of another person's clitoris. Thus, while the branch included on some vibrators may suit some users, these vibrators may fail to stimulate other users.

Thus, it would be desirable to provide a personal massage device that can be adapted to suit any individual user and which can deliver precisely targeted dual stimulation to the clitoris and “G-Spot” of a user.

### SUMMARY OF INVENTION

According to an aspect of the invention there is provided a personal massage device, for interaction with a user's body, comprising: a base comprising a base section and a clitoral stimulation motor, the base section and the clitoral stimulation motor each having a main longitudinal axis, the main longitudinal axis of the clitoral stimulation motor subtending an angle to the main longitudinal axis of the base section; and a shaft comprising a first shaft section and a second shaft section; wherein the base and the first shaft section form a first flexible section, bendable in a first rotational direction, and the first shaft section and the second shaft section form a second flexible section, bendable in a second rotational direction, such that the device can be bent from a first configuration to a second configuration; wherein a component of the second rotational direction is opposite to the first rotational direction; and the flexible sections resist bending such that the device resists bending from the first configuration to the second configuration and maintains its shape in use.

Thus, the device can be bent into different complex shapes and maintain its shape whilst in use. This allows a user to adapt the shape of the personal massage device to suit their body and maximise the effectiveness of the device. For example, the user may adapt the shape of the device to maximise contact with the “G-spot”. In one example, initially the shaft is substantially straight. Then, the first flexible section is bent clockwise and the second flexible section is bent anti-clockwise. Now, the device forms a sinuous or “S” shape which may stimulate an individual user more effectively than if it were curved or simply straight. In this example, the flexible sections resist bending such that the device will maintain its sinuous shape whilst in use. The user may decide to revert back to the straight shape at a later point. To do this the user bends the first flexible section anti-clockwise and the second flexible section clockwise until the shaft is substantially straight. Preferably, the shaft of the personal massage device is arranged for insertion into an orifice of the user and, preferably, one or more flexible sections are positioned along the length of the part of the shaft that is arranged for insertion.

Thus, the shape of the part of the shaft that interacts with the inside of the user can be altered which may enhance sexual stimulation.

By providing a flexible section formed from the base section and the first shaft section, the base can be positioned in a way that the user's clitoris or labia is stimulated when the shaft is inserted into the user's vagina. More specifically, the first flexible section may be bent such that the vibrations from the clitoral stimulation motor provide stimulation to the user's clitoris or labia during use. This stimulation is advantageously improved by arranging the clitoral stimulation motor at an angle to the base section.

The base section is arranged to support the shaft sections. Thus, the base may be used as a handle for controlling the position of the shaft inside the user. In use, typically the base will not be inserted into the user.

These features contribute towards providing a personal massage device that can be adapted to suit any individual user and which can deliver precisely targeted dual stimulation to the clitoris and “G-Spot” of a user. Dual stimulation is the most effective way to create arousal and orgasm, so by enabling this dual stimulation the device provided in the present invention can deliver extremely effective sexual stimulation to a user.

The angle subtended by the main longitudinal axis of the clitoral stimulation motor to the main longitudinal axis of the base section is preferably acute and angle towards the shaft, such that the tip of the clitoral stimulation motor (i.e. the end of the clitoral stimulation motor distal to the base section) is nearer to the tip of the shaft than the base of the clitoral stimulation motor (i.e. the end of the clitoral stimulation motor proximal to the base section).

The main longitudinal axis of the clitoral stimulation motor more preferably subtends an angle of between 30° and 45° to the main longitudinal axis of the base section, and still more preferably subtends an angle of between 35° and 40° to the main longitudinal axis of the base section. Most preferably, the clitoral stimulation motor subtends an angle of between 37° and 38° to the main longitudinal axis of the base section.

Preferably, the base section and the shaft sections are at least partially encased by a protective cladding comprising a flexible material. In this way, the base section and the shaft sections form an internal chassis and the protective cladding forms an outer moulding at least partially covering the internal chassis. This helps to protect the motors and circuitry of the device from damage during use. The cladding is preferably also water resistant so as to further prevent damage during use as well as to allow for the device to be more easily cleaned. Preferably, the cladding comprises a flexible material such as rubber material, preferably silicone rubber. Silicone rubber is particularly effective at reducing noise from the motors whilst not reducing the intensity of the vibrations. The internal chassis (formed by the base section and the shaft sections), motors, and circuitry of the device are most preferably entirely encased within the protective cladding.

The clitoral stimulation motor is preferably encased in the protective cladding in a “floating” configuration. By encasing the clitoral stimulation motor in the protective cladding, the vibrations of the clitoral stimulation motor may be transferred to the user more effectively. Furthermore, this mechanically isolates the clitoral stimulation motor from the base section, thereby preventing unwanted transfer of vibrations to the base section, which would reduce the stimulation experienced by the user.

In order to further enhance the stimulation of the user, the protective cladding preferably comprises a pair of fins, the clitoral stimulation motor being positioned between the fins. Each fin takes the form of an elongate flexible protrusion from the protective cladding which has a substantially triangular cross-section, with the fins being arranged to receive at least a portion of the user's clitoris or labia between them. The fins are also preferably configured to be vibrated by the clitoral stimulation motor, so as to enhance the sexual stimulation of the user.

The fins each rise to an apex, or peak, in a region adjacent to the clitoral stimulation motor with one side, or slope, aligned with (i.e. substantially parallel to) the main longitudinal axis of the clitoral stimulation motor. In this way, when a user's clitoris or labia are, at least partially, received between the fins they will be directly stimulated by the vibrations of the clitoral stimulation motor as well as being stimulated by the vibrations of the fins. To further enhance this stimulation, the fins may be angled inwardly, i.e. towards the clitoral stimulation motor.

At least one other vibration motor may also be at least partially encased by a protective cladding. This helps to prevent any of the motors being damaged in use. In addition, this helps to isolate the vibrations of the motors from one another so that they may be felt individually.

The shaft typically comprises a third shaft section, the second shaft section and the third shaft section forming a third flexible section, the third flexible section being bendable in the first rotational direction and the second rotational direction. The shaft may also comprise one or more further shaft sections so as to form one or more further flexible sections. For example, the shaft may comprise a fourth shaft section such that the third shaft section and the fourth shaft section form a fourth flexible section. In general, the nth shaft section forms an nth flexible section with the (n-1)th shaft section. The one or more further flexible sections are bendable in the first rotational direction and the second rotational direction.

Preferably, the flexible sections are bendable independently of one another. This gives the user greater control over the shape of the stimulator.

Preferably, each respective flexible section does not bend when subject to a magnitude of torque below a selected threshold and bends when subject to a magnitude of torque above the selected threshold. Preferably, the threshold is selected so that the flexible section does not bend when the personal massage device is used for sexual stimulation, for example, when the shaft is inserted into and removed from an orifice of the user. Thus, the personal massage device is able to maintain its shape whilst in use. Preferably, the threshold is selected so that the flexible section can be bent by hand.

Each flexible section may be described as being “non-resilient” such that each flexible section can be bent from a straight position to a bent position without returning to the straight position and vice versa.

Preferably, each flexible section can be bent to define any one of a plurality of angles. For example, a respective flexible section may be bent to define an angle between 0° and 90°. Preferably, the second flexible section is bendable in the first rotational direction as well as the second rotational direction. In this way the shaft is able to be bent into a curved shape or a sinuous shape. Preferably, the first flexible section is bendable in the second rotational direction as well as the first rotational direction. Preferably, the second rotational direction is opposite the first rotational direction. Preferably, each one of the flexible sections is arranged to be bent in only the first or the second rotational directions.

Preferably, the flexible sections are bendable in a first plane and resist bending outside the first plane. Preferably, a length axis of the shaft is contained within the first plane. Preferably, the flexible sections are bendable in the first plane but resist bending in all other planes.

Each one of the flexible sections may be arranged to be bent about an axis. Each axis may be arranged substantially perpendicularly to the length of the shaft. These axes may extend in substantially the same direction as one another.

The device may comprise a plurality of flexible sections. Preferably, the device comprises at least five flexible sections. This allows the device to be bent into a variety of complex shapes whilst maintaining a simple design.

Preferably, each flexible section is articulated. For example, each flexible section may comprise a hinge. Preferably, each hinge is arranged to resist bending such that the device resists bending from the first configuration to the second configuration. Preferably, the hinge is a “friction-hinge”, otherwise known as a “constant torque hinge”.

Preferably, each hinge does not bend when subject to a magnitude of torque below a selected threshold and bends when subject to a magnitude of torque above the selected threshold. Preferably, the threshold is selected so that the hinge does not bend when the personal massage device is used for sexual stimulation, for example, when the shaft is inserted into and removed from an orifice of the user. Thus, the personal massage device is able to maintain its shape whilst in use. Preferably, the threshold is selected so that the hinge can be bent by hand.

Preferably, the personal massage device further comprises a tip vibration motor positioned towards the tip of the shaft. The tip motor may be used to stimulate the users' G-spot. Preferably, this motor is positioned inside the tip of the shaft.

Preferably, the personal massage device further comprises at least one shaft vibration motor positioned along the length of the shaft. The shaft vibration motor enhances the sexual stimulation provided by the shaft. Preferably, the personal massage device comprises a plurality of shaft vibration motors positioned along the length of the shaft. By positioning a plurality of vibration motors along the length of the shaft their effect can be spread out, maximising their effectiveness. Preferably, the personal massage device comprises four shaft vibration motors positioned along the length of the shaft.

Preferably, the tip vibration motor is arranged to vibrate with a greater amplitude than the at least one shaft vibration motor. It is advantageous that the vibrations provided by the tip vibration motor are more intense than those of the shaft vibration motor because the tip vibration motor is arranged to stimulate the G-spot.

Preferably, each one of the plurality of shaft vibration motors is positioned with its longest axis substantially perpendicular to the length axis of the shaft. This enables a plurality of motors to be provided within a shaft of a particular length.

Preferably, the tip vibration motor is positioned with its longest axis substantially parallel with the length axis of the shaft. In this way, the tip motor may point towards the users' G-spot which may help to enhance sexual stimulation.

Preferably, each one of the plurality of shaft vibration motors is positioned between a pair of adjacent flexible sections or hinges. Arranging the shaft vibration motors in this way helps to allow the vibrations provided by each motor to be felt individually by the user. Preferably, only one motor is positioned between a pair of adjacent flexible sections or hinges.

Preferably, the personal massage device further comprises a housing provided between each pair of adjacent flexible sections or hinges; and the housing is arranged to receive a shaft vibration motor. In this way, shaft vibrator motors may be held securely.

The personal massage device may further comprise a control module arranged to control the vibration motors independently from one another. The control module may be arranged to control the amplitude at which each one of the vibration motors vibrates. Preferably, the controller is arranged to control the amplitude at which the vibration motors vibrate independently from one another. The control module may be arranged to control the frequency at which each one of the vibration motors vibrates. Preferably, the controller is arranged to control the frequency at which the vibration motors vibrate independently from one another.

The personal massage device may further comprise a storage module arranged to store at least one set of instructions arranged to be used by the control module to control the motors independently from one another. Preferably, the storage module is arranged to store a plurality of sets of instructions. Preferably, the storage module is rewritable. The storage module may be a removable storage medium such as a nonvolatile memory card.

The personal massage device may further comprise at least one communication module arranged to provide the storage module with sets of instructions. The communication module may use a physical connection, such as a USB connection, or a wireless connection, such as a Bluetooth connection.

The personal massage device is configured to be adapted to suit any individual user and thereby to provide enhanced sexual stimulation. In addition to being used as a wellness device for pleasure, the personal massage device can be used as a medical device for pain relief. By providing a device which is flexible along its length and which holds the shape that it bends to, precise external stimulation to the clitoris and labia of a user and precise internal stimulation to the vagina and “G-spot” of a user can be delivered.

### BRIEF DESCRIPTION OF DRAWINGS

Embodiments of the present invention will now be described, by way of example only, with reference to the accompanying drawings, in which:

FIG. 1 shows a perspective view of a personal massage device;

FIG. 2 shows a schematic view of the personal massage device in a straight position;

FIG. 3 shows a schematic view of the personal massage device in a bent position;

FIG. 4 shows a perspective view of an upper side of the personal massage device;

FIG. 5 shows an internal chassis for the personal massage device in a straight position;

FIG. 6 shows the internal chassis in a multi-curved position;

FIG. 7 shows the internal chassis in a single-curved position; and

FIG. 8 shows a schematic diagram of a control system for a personal massage device.

### DETAILED DESCRIPTION

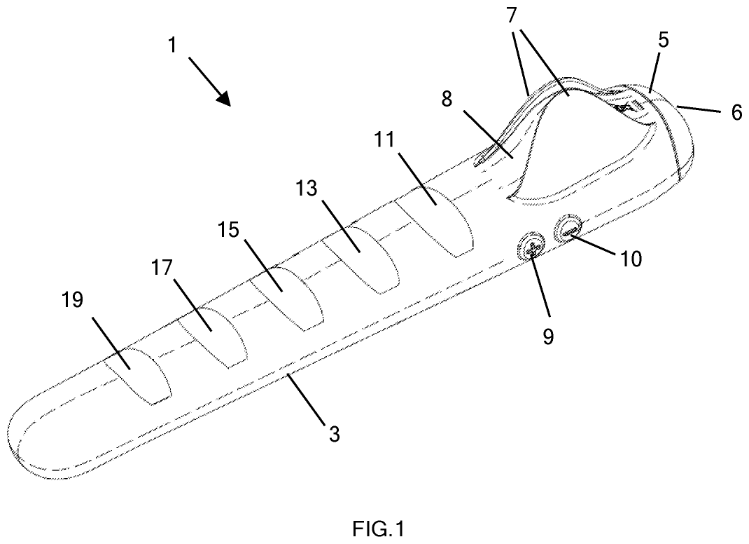

Referring to FIG. 1, there is provided a personal massage device 1 comprising a shaft 3 and a base 5. Typically, a user grips the base 5 of the stimulator 1 with one hand and inserts the shaft 3 into their vagina for sexual stimulation. The base 5 comprises a pair of fins 7 which can be used to stimulate the user's clitoris whilst the shaft 5 is inside the user's vagina. The base 5 further comprises a pair of buttons 9, 10 for controlling the personal massage device 1 and a charging port 6 for charging the device. The device also includes a protrusion 8 between the fins 7 which houses a clitoral stimulation motor.

The device 1 comprises five flexible sections 11, 13, 15, 17, 19 positioned along the length of the device 1. These flexible sections can be used to bend the device 1 into a variety of different shapes. Thus, the device 1 can be adapted to suit any individual user.

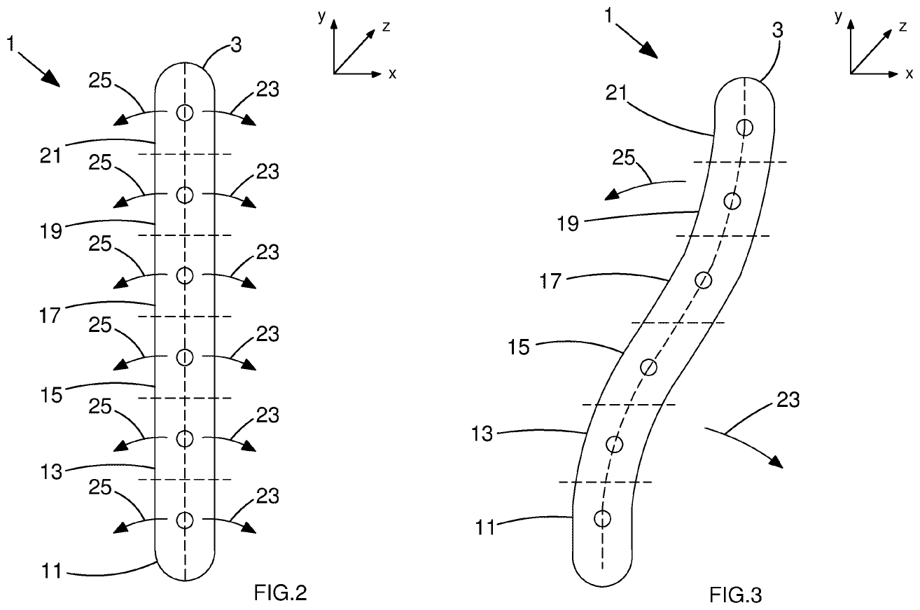

FIG. 2 shows a schematic representation of a personal massage device 1 having six flexible sections 11, 13, 15, 17, 19, 21 with the device 1 in a straight position. In this position each one of the flexible sections 11, 13, 15, 17, 19, 21 is straight. Each flexible section can be bent in either a first rotational direction 23 or a second rotational direction 25. The first rotational direction 23 and the second rotational direction 25 directly oppose one another. The first rotational direction 23 may be described as ‘clockwise’ whilst the second rotational direction 25 may be described as ‘anti-clockwise’.

The first rotational direction 23 and the second rotational direction 25 are both in the x-y plane. Neither the first rotational direction 23 nor the second rotational direction 25 has a component which acts in the y-z plane. Thus, the device 1 will bend in the y-x plane. The device 1 does not bend in the y-z plane. This provides a simple design that enables the device 1 to adapt to a particular user.

Each one of the flexible sections 11, 13, 15, 17, 19, 21 bends about an axis which extends in the direction of the z-axis, which is perpendicular to the length of the device 1. In the position shown, these axes are aligned along the length of the device 1 and extend in the same direction. It would be possible to arrange the flexible sections such that the axes do not all extend in the same direction. In this arrangement each axis extends in a direction that has a component in the z-axis and the x-axis. In this example, each flexible section is able to bend in a clockwise and in an anti-clockwise direction; however, each rotational direction would have a component which acts in the y-z plane as well as the x-y plane. This allows the shaft to bend in a plurality of planes as opposed to a single plane.

FIG. 3 shows a schematic view of the personal massage device 1 of FIG. 2 with the device 1 in a bent position. To change the shape of the device 1 from the straight shape shown in FIG. 2 to the bent shape shown in FIG. 3 the user bends the bottom three flexible sections 11, 13, 15 in the first rotational direction 23; then, the user bends the top three flexible sections 17, 19, 21 in the second rotational direction 25. This positions the shaft 3 in the multi-curved shape shown in FIG. 3. This shape may be described as sinuous or ‘S’ shaped. The user may experience greater sexual stimulation with the shaft 3 in the bent position than in the straight position because this position may maximise the shaft's contact with the user's G-spot.

The flexible sections are flexible enough to be bent by hand. However, they are stiff enough to resist bending out of shape when the personal massage device is in use. The flexible sections should not bend when the device 1 is inserted and removed from an orifice of the user.

The personal massage device 1 provided according to embodiments of the present invention comprises an internal chassis 31 inside a protective cladding. The protective cladding is provided over the internal chassis 31 and protects it from fluids.

The internal chassis 31 comprises a base section 33 which connects to a first shaft section 35, which connects to a second shaft section 37, which connects to a third shaft section 38, which connects to a fourth shaft section 39, which connects to a tip section 41. In addition to the buttons 9, 10, the base section comprises a pair of buttons 27, 29 for controlling the personal massage device 1. The internal chassis could include further shaft sections positioned between the fourth shaft section 39 and the tip section 41.

The base section 33 is connected to the first shaft section 35 by a first friction hinge 43 which forms part of the first flexible section 11. The first shaft section 35 is connected to the second shaft section 37 by a second friction hinge 45 which forms part of the second flexible section 13. The second shaft section 37 is connected to the third shaft section 38 by a third friction hinge 47 which forms part of the third flexible section 15. The third shaft section 38 is connected to the fourth shaft section 39 by a fourth friction hinge 49 which forms part of the fourth flexible section 17. The fourth shaft section 39 is connected to the tip section 41 by a final friction hinge 53 which forms part of the final flexible section 19. In the case that further shaft sections are positioned between the fourth shaft section 39 and the tip section 41, these will be connected by further friction hinges so as to form further flexible sections.

The personal massage device 1 comprises six vibration motors which vibrate in order to provide and/or enhance sexual stimulation. Each vibration motor provides vibrations by using an electric motor to rotate an off-centre weight. Each vibration motor is protected by a silicone rubber cladding which helps to reduce noise without significantly dampening the vibrations of the motors. The cladding also helps to separate the vibrations of the motors from one another so that they can be felt individually. The base section 33 comprises a battery and a control module for controlling the vibration motors. The user is able to send instructions to the control module using the buttons 9, 10, 27, 29.

The base 5 further comprises a base vibration motor 55, also referred to as a clitoral stimulation motor 55, which is used to stimulate a user's clitoris and/or labia and to vibrate the pair of fins 7.

There are four shaft vibration motors 57, 59, 61, 63 positioned along the length of the shaft 3. There is a tip vibration motor 65 at the end of the shaft 3.

The first shaft vibration motor 57 is housed within the first shaft section 35 between the first hinge 43 and the second hinge 45. The second shaft vibration motor 59 is housed within the second shaft section 37 between the second hinge 45 and the third hinge 47. The third shaft vibration motor 61 is housed within the third shaft section 38 between the third hinge 47 and the fourth hinge 49. The fourth shaft vibration motor 63 is housed within the fourth shaft section 39 between the fourth hinge 49 and the fifth hinge 53. The tip vibration motor is housed within the tip section 41. The shaft vibration motors are separated from one another in their individual housings in order to separate the vibrations of the motors from one another so that they can be felt individually. The off-centre weight of each shaft vibration motor is exposed outside of the cladding so that the vibrations can be felt more easily.

The base vibration motor 55 and the tip vibration motor 65 are typically both the same size. The shaft vibration motors 57, 59, 61, 63 are the same size as one another. Each one of the base vibration motor 55 and the tip vibration motor 65 is larger than each one of the shaft vibration motors 57, 59, 61, 63. Each one of the base vibration motor 55 and the tip vibration motor 65 is able to vibrate at a greater amplitude than each one of the shaft vibration motors 57, 59, 61, 63. The tip vibration motor 65 is positioned so that its longest axis extends in the same direction as the length of the shaft 3. Thus, the tip vibration motor 65 can point towards the user's G-spot when the shaft is inside the user. The shaft vibration motors 57, 59, 61, 63 are positioned so that their longest axes extend perpendicularly to the length of the shaft 3. This prevents the personal massage device 1 from being too long to use.

Each friction hinge comprises protrusions in the adjacent sections. As an example, the first shaft section 57 is connected to the second shaft section 59 by the second friction hinge 45. The second friction hinge 45 comprises two pairs of protrusions attached to the first shaft section 35 and two attached to the second shaft section 37. Each of the protrusions attached to the second shaft section 37 fits inside slots formed in the two pairs of protrusions attached to the first shaft section 35. Each protrusion has a hole through it which is arranged to receive a bolt. A bolt extends through one pair of the protrusions attached to the first shaft section 35 and the corresponding protrusion attach to the second shaft section 37, and a second bolt extends through the other pair of the protrusions attached to the first shaft section 35 and the corresponding protrusion attach to the second shaft section 37. This forms the second friction hinge 45. The bolts can be tightened or loosened in order to select the hinge's stiffness. The hinge's stiffness is selected so that the hinge can be bent by hand but so that it does not bend when inserted into an orifice of the user.

The personal massage device 1 may comprise an induction coil within the base which allows the battery to be charged wirelessly so as to avoid the need for an external physical electrical connection to be provided. However, the personal massage device 1 typically comprises charging port 6.

The shaft vibration motors 57, 59, 61, 63 are preferably of a push fit design received in cavities in the respective shaft sections 35, 37, 38, 39. A bendable flexi circuit provides the electrical connections between the motors 55, 57, 59, 61, 63, 65 and the control electronics situated in the base 5. In this way the range of motion of the flexible sections is not limited by the electrical connections.

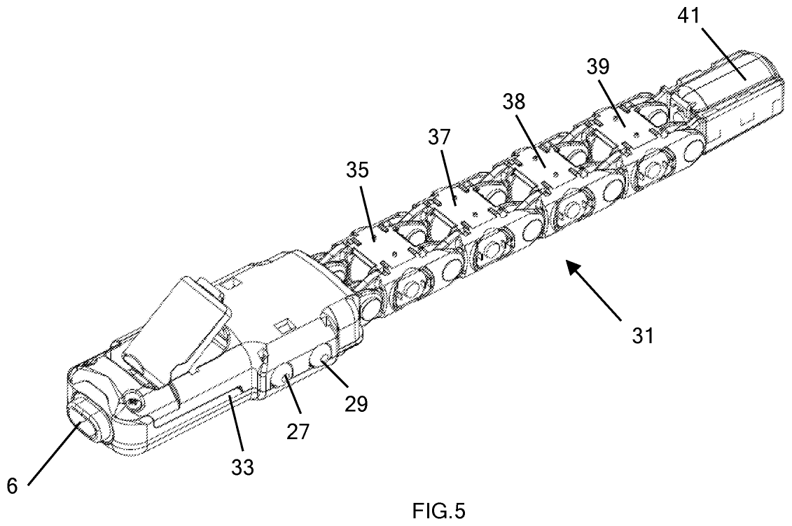

FIG. 5 shows the internal chassis 31 which in this example comprises the base section 33, the first shaft section 35, the second shaft section 37, the third shaft section 38, the fourth shaft section 39 and the tip section 41. The internal chassis 31 may also be provided with a fifth shaft section; however, in this example, a fifth shaft section has been omitted. In FIG. 5 the internal chassis 31 is in the straight position. In this position, the base section 33, the shaft sections 35, 37, 38, 39 and the tip section 41 are positioned in a straight line. The friction hinges resist bending such that the shaft 3 remains straight whilst in use.

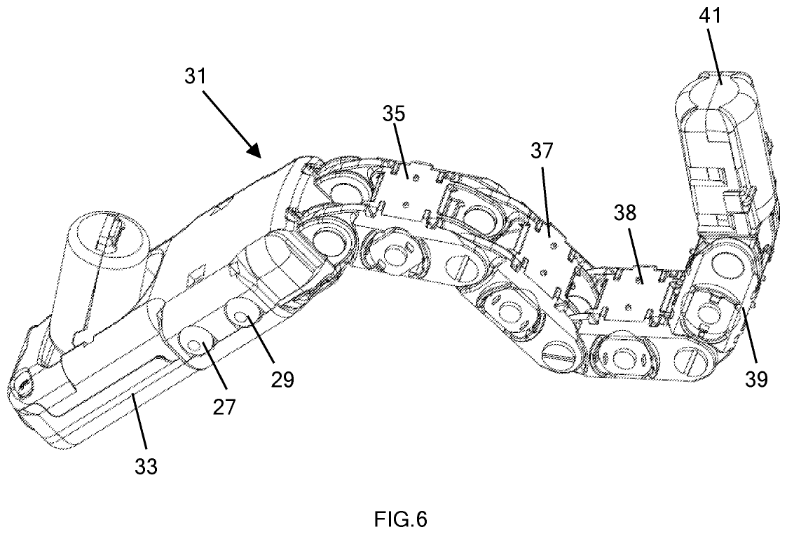

In FIG. 6 the internal chassis 31 is in a bent position, defining a sinuous path. In this position, the first shaft section 35 is bent clockwise relative to the base section 33; the second shaft section 37 is bent clockwise relative to the first shaft section 35; the third shaft section 38 is bent anti-clockwise relative to the second shaft section 37; the fourth shaft section 39 is bent anti-clockwise relative to the third shaft section 38; and the tip section 41 is bent anti-clockwise relative to the fourth shaft section 39. Thus, the internal chassis is bent in two different directions which defines an “S” shape. A user may find the “S” shaped shaft more sexually stimulating than the straight shaft because it may increase contact with the user's G-spot.

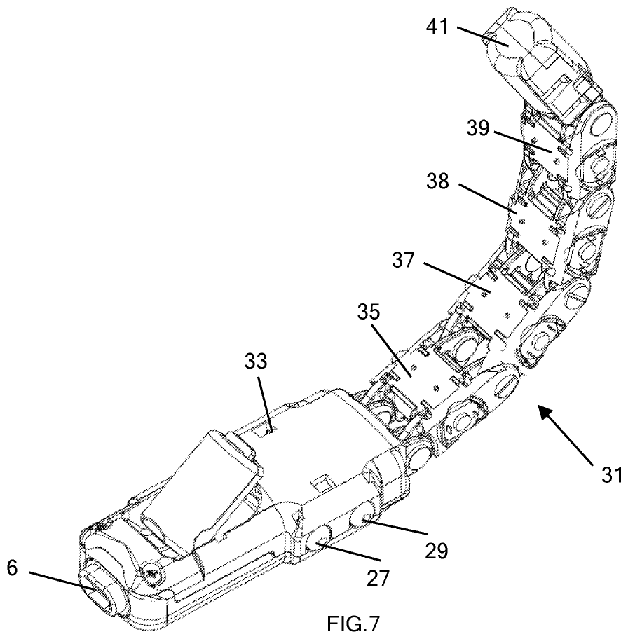

In FIG. 7 the internal chassis 31 is in a bent position, defining a single-curved path. In this position, base section 33, shaft sections 35, 37, 38, 39 and tip section 41 are bent anti-clockwise relative to one another. Thus, the internal chassis bents in a single direction defining a “C” shape. A different user may find the “C” shaped shaft more sexually stimulating than the straight or “S” shaped shaft because it may increase contact with that user's G-spot.

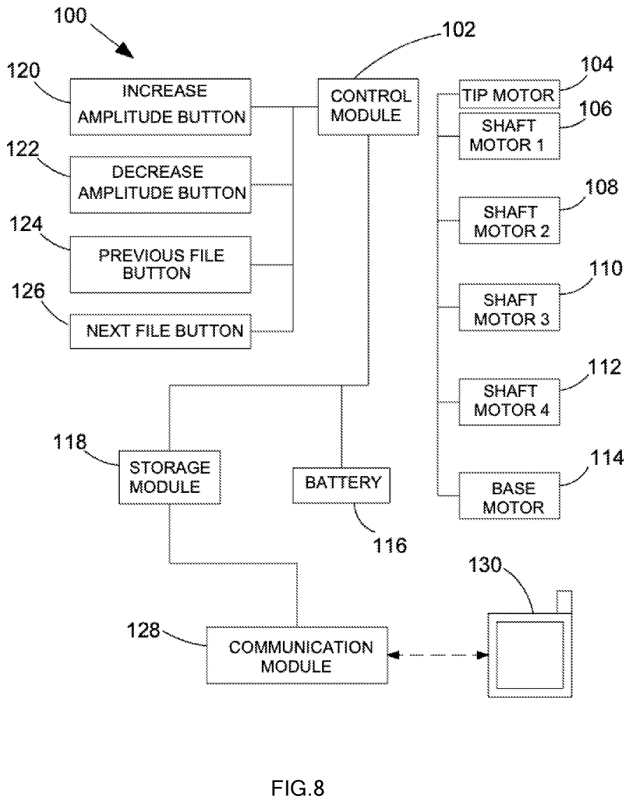

FIG. 8 shows a schematic diagram of a control system 100 for a personal massage device which may be used to control the personal massage device 1 described above. The control system 100 comprises a control module 102 which is used to control a plurality of vibration motors. In this example, the control module 102 is used to control a tip vibration motor 104, four shaft motors 106, 108, 110, 112 and a base motor 114. These vibration motors correspond with the vibration motors of the personal massage device 1 described above; however, the control module 102 may be used to control a different number and arrangement of vibration motors.

The control system 100 includes a battery 116 which provides electrical power to the vibration motors and the modules within the control system 100. The control module 102 can control the amplitude and frequency at which each one of vibration motors 104, 106, 108, 110, 112, 114 vibrates. Typically, the control module 102 will use a pulse-wave modulated signal to control each motor. If the control module 102 sends a signal with high amplitude to a motor, the motor will vibrate with a high amplitude or intensity. If the control module 102 sends a signal with low amplitude to the motor, the motor will vibrate with low amplitude or intensity. If the control module 102 sends a signal with high frequency to the motor, the motor will vibrate at a high frequency. If the control module 102 sends a signal with low frequency to the motor, the motor will vibrate with low frequency. The control module 102 is able to control the vibration motors independently of one another. The control module 102 can be used to vibrate the motors in a way that provides and/or enhances any sexual stimulation provided by the personal massage device.

The control system 100 comprises a storage module 118 which is arranged to store a plurality of data files. Each data file defines a set of instructions which is used by the control module 102 to vibrate the motors. One data file may instruct the vibration motors to vibrate at a gradually increasing intensity and frequency over a pre-set period of time, for example, five minutes. Another data file may instruct the vibration motors to increase and decrease the intensity and frequency of vibrations in a rhythmic cycle. In each of these examples, the instructions may cause the motors towards the tip to vibrate more strongly than the motors towards the base or vice versa.

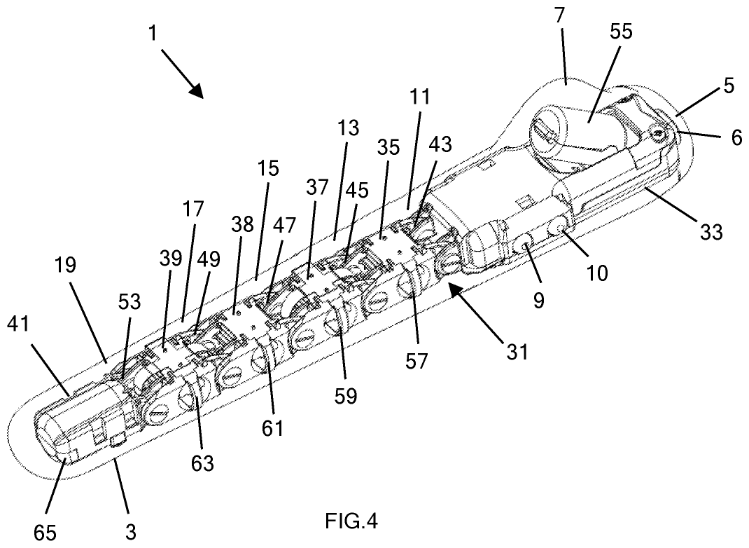

The control system 100 comprises four buttons 120, 122, 124, 126 for controlling the control module. There is “increase amplitude button” 120 which is used to increase the overall amplitude of the vibrations of the motors and a “decrease amplitude button” 122 which is used to decrease the overall amplitude of the vibrations of the motors. The user can activate these buttons to change the overall amplitude of the vibrations in an incremental fashion. However, the relative difference between the amplitudes of vibration of the motors will remain as defined by the data file in use at that time. There is a “previous file button” 124 which is used to select the previous data file stored in the storage module 118. There is a “next file button” 126 which is used to select the next data file stored in the storage module 118. The “increase amplitude button” 120 and the “decrease amplitude button” 122 may correspond with the first pair of buttons 9, 10 shown in FIGS. 1 and 4. The “previous file button” 124 and the “next file button” 126 may correspond with the second pair of buttons 27, 29 shown in FIGS. 5 to 7. The personal massage device 1 can be activated by holding down the “increase amplitude button” 120 for a predefined period of time. The personal massage device can be de-activated by holding down the “decrease amplitude button” 122 for a predefined period of time. The control system 100 comprises a communication module 128 which is arranged to receive data files from external sources. The communication module 128 receives data files and stores them at the storage module 118.

The communication module 128 can connect wirelessly via Bluetooth to a client device 130. The client device 130 may be the user's smart phone or tablet computer. Data files can be sent from the client device 130 to the communication module 128 which in turn are stored at the storage module 118. In addition, the client device 130 can be used to re-order, remove or delete data files stored at the storage module 118. Preferably, the communication module 128 connects wirelessly with the client device 130; however, a physical connection such as USB may be provided.

The control system 100 has been described in the context of the personal massage device 1 described above. However, the control system 100 may be used to control any personal massage device comprising at least two vibration motors.

1. A personal massage device, for interaction with a user's body, comprising:
a base comprising a base section and a clitoral stimulation motor, the base section and the clitoral stimulation motor each having a main longitudinal axis, the main longitudinal axis of the clitoral stimulation motor subtending an angle to the main longitudinal axis of the base section; and
a shaft comprising a first shaft section and a second shaft section,
wherein the base section and the first shaft section form a first flexible section, bendable in a first rotational direction, and the first shaft section and the second shaft section form a second flexible section, bendable in a second rotational direction, such that the device can be bent from a first configuration to a second configuration,
wherein a component of the second rotational direction is opposite to the first rotational direction; and the first and second flexible sections resist bending such that the device resists bending from the first configuration to the second configuration and maintains its shape in use.

2. The personal massage device according to claim 1, wherein the main longitudinal axis of the clitoral stimulation motor subtends an angle of between 30° and 45° to the main longitudinal axis of the base section, and preferably subtends an angle of between 35° and 40° to the main longitudinal axis of the base section, and more preferably subtends an angle of between 37° and 38° to the main longitudinal axis of the base section.

3. The personal massage device according to claim 1, wherein the base section and the shaft sections are at least partially encased by a protective cladding comprising a flexible material.

4. The personal massage device according to claim 3, wherein the clitoral stimulation motor is encased in the protective cladding.

5. The personal massage device according to claim 4, wherein the protective cladding comprises a pair of fins, the clitoral stimulation motor being positioned between the fins.

6. The personal massage device according to claim 1, wherein the second flexible section is bendable in the first rotational direction and the second rotational direction.

7. The personal massage device according to claim 1, wherein the first flexible section is bendable in the second rotational direction and the first rotational direction.

8. The personal massage device according to claim 1, wherein the second rotational direction is substantially opposite the first rotational direction.

9. The personal massage device according to claim 1, wherein the shaft further comprises a third shaft section, the second shaft section and the third shaft section forming a third flexible section, the third flexible section being bendable in the first rotational direction and the second rotational direction.

10. The personal massage device according to claim 9, wherein the shaft comprises one or more further shaft sections so as to form one or more further flexible sections.

11. The personal massage device according to claim 1, wherein the flexible sections are bendable independently of one another.

12. The personal massage device according to claim 1, wherein each respective flexible section does not bend when subject to a magnitude of torque below a selected threshold and bends when subject to a magnitude of torque above the selected threshold.

13. The personal massage device according to claim 12, wherein the threshold is selected so that the flexible section does not bend when the personal massage device is used for sexual stimulation.

14. The personal massage device according to claim 1, wherein the flexible sections are bendable in a first plane but resist bending in another plane.

15. The personal massage device according to claim 1, further comprising a tip vibration motor positioned towards the tip of the shaft.

16. The personal massage device according to claim 1, further comprising a plurality of shaft vibration motors positioned along the length of the shaft.

17. The personal massage device according to claim 9, wherein the flexible sections are bendable independently of one another.

18. The personal massage device according to claim 17, wherein each respective flexible section does not bend when subject to a magnitude of torque below a selected threshold and bends when subject to a magnitude of torque above the selected threshold.

19. The personal massage device according to claim 18, wherein the threshold is selected so that the flexible section does not bend when the personal massage device is used for sexual stimulation.
